(19) United States
(12) Patent Application Publication
(10) Pub. No.: US 2019/0324123 A1
(43) Pub. Date: Oct. 24, 2019

(54) INTEGRATED ROTARY MACHINE CHIP FOR LASER RADAR SENSOR

(71) Applicant: JINHUA LANHAI PHOTOELECTRICITY TECHNOLOGY CO.,LTD., Jinhua (CN)

(72) Inventors: Weicai Yu, JINHUA (CN); Chongqiu Liu, JINHUA (CN); Yue Wang, JINHUA (CN)

(73) Assignee: JINHUA LANHAI PHOTOELECTRICITY TECHNOLOGY CO.,LTD.

(21) Appl. No.: 16/385,397

(22) Filed: Apr. 16, 2019

(30) Foreign Application Priority Data
Apr. 20, 2018 (CN) 201810359115.8

(51) Int. Cl. G01S 7/481; G01S 17/08

(52) U.S. Cl. CPC G01S 7/4817; G01S 7/4811; G01S 17/08

(57) ABSTRACT

The present invention discloses an integrated rotary machine chip for a laser radar sensor, comprising: a machine chip body, wherein two positioning bearings are arranged on the upper side and the lower side of the machine chip body respectively, the machine chip body includes a ranging transmitting board, a ranging receiving board, a laser ranging transmitting module, a laser ranging receiving module and a ranging mainboard, wherein the ranging transmitting board and the ranging receiving board are arranged on two sides of the machine chip body respectively. The present invention guarantees the optical path consistency before and after optically debugging the machine chip and adding the optical enclosure, and increases the ranging accuracy and stability; the machine chip is integrated in one piece, the three-dimensional space of the machine chip reasonably used, and the number of components is reduced.

### TECHNICAL FIELD

The present invention relates to the field of laser ranging, particularly to an integrated rotary machine chip for a laser radar sensor.

### BACKGROUND

In the field of existing rotary laser ranging devices, based on the limitations of optical and structural principles, the existing laser sensors with optical protective enclosures substantially use bearings to fix either the upper part or the lower part of a rotary workbench at one side, thereby achieving the purpose of rotary ranging. Since a single-end-face bearing is fixed/limited, the swing of the other end of the bearing may bring inevitable repeated high-intensity vibration work due to the fact that the whole product life cycle is long, and the whole product is usually used for anti-collision, assisted driving and other occasion, thus the wear on the rotating laser ranging device is quite obvious, more obvious especially in the middle usage cycle and the late usage cycle of the product, which is directly embodied in that the shake of the laser ranging device is increased, the ranging accuracy is reduced, the ranging data is reported incorrectly, and the service life of the product is shortened until the product is discarded.

To solve the above-mentioned problem, in combination with the current demand, that is, the market has higher requirements for product stability and small size, the present invention proposes an integrated rotary machine chip for a laser radar sensor.

### SUMMARY

In view of the problems existing in the prior art, the present invention provides an integrated rotary machine chip for a laser radar sensor.

To solve the above technical problems, the present invention adopts the following technical solution:

An integrated rotary machine chip for a laser radar sensor, comprising: a machine chip body, wherein two positioning bearings are arranged on the upper side and the lower side of the machine chip body respectively, the two positioning bearings are coaxial, the machine chip body includes a ranging transmitting board, a ranging receiving board, a laser ranging transmitting module, a laser ranging receiving module and a ranging mainboard, wherein the ranging transmitting board and the ranging receiving board are arranged on the front side and the rear side of the machine chip body respectively, the ranging mainboard is arranged on the left side of machine chip body, the machine chip body is provided with a transmitting cavity and a receiving cavity, the transmitting cavity is located right above the receiving cavity, and the laser ranging transmitting module and the laser ranging receiving module are located in the transmitting cavity and the receiving cavity respectively. Wherein, the transmitting cavity and the receiving cavity are interchangeable in position according to actual needs.

Preferably, the laser ranging transmitting module comprises a transmitting reflector adjusting slider and a ranging transmitting lens fixed to the transmitting reflector adjusting slider, and the laser ranging receiving module comprises a receiving reflector adjusting slider and a ranging receiving lens fixed to the receiving reflector adjusting slider, wherein the transmitting reflector adjusting slider and the receiving reflector adjusting slider are used to adjust positions of corresponding lenses.

Preferably, the integrated rotary machine chip for a laser radar sensor further comprises a brushless motor rotor, a wireless power supply mechanism, an upper wireless photoelectric communication circuit board and a lower wireless photoelectric communication circuit board, wherein the brushless motor rotor is connected with the machine chip body to drive the machine chip body to rotate, and the upper wireless photoelectric communication circuit board is communicatively connected with the lower wireless photoelectric communication circuit board; one end of the wireless power supply mechanism is electrically connected with the lower wireless photoelectric communication circuit board, the other end thereof is electrically connected with the ranging mainboard and the upper wireless photoelectric communication circuit board, and the wireless power supply mechanism is used to supply power for the laser ranging module.

Preferably, a grating structure and a photoelectric switch matched with the grating structure are arranged at the bottom of the machine chip body, the photoelectric switch is matched with the grating structure to detect the rotation speed, the brushless motor rotor is located on the inside of the grating structure, and the brushless motor rotor is surrounded by the grating structure.

Preferably, the wireless power supply mechanism supplies power for a magnetic core or supplies power for an internal/external transformer.

Preferably, the ranging transmitting lens is a 45-degree angle reflector or a 45-degree angle prism, and the ranging receiving lens is a 45-degree angle reflector or a 45-degree angle prism.

Preferably, the machine chip body is also provided with a counterweight.

Preferably, an enclosure is also arranged on the outside of the machine chip body, the machine chip body is surrounded by the enclosure, and the transmitting cavity and receiving cavity are in small clearance fit with the inner wall of the enclosure.

Preferably, a base matched with the machine chip body is arranged at the bottom of the machine chip body.

Because of adopting the above-mentioned technical solution, the present invention has the significant technical effects that: in the present invention, by arranging two coaxial positioning bearings on the upper side and the lower side of the machine chip body, high accuracy and stability of matching of the machine chip body are guaranteed, and the ranging accuracy of the product is increased and stabilized; each part of the laser ranging module is reasonably fixed to the machine chip body, the transmitting optical path and the receiving optical path may be accurately adjusted by corresponding reflector adjusting sliders, small space is occupied after integration, and the whole volume is greatly reduced; the machine chip is integrated in one piece and may be equipped with various modules required thereby, the various modules are reasonably and precisely equipped on the machine chip body, the three-dimensional space of the machine chip is fully and reasonably used, the number of components is reduced, machining and assembling are simplified, and the machine chip is low in cost and small in volume.

### DESCRIPTION OF DRAWINGS

FIG. 1 is a part drawing of an integrated rotary machine chip body of the present invention.

FIG. 2 is a sectional view of the present invention.

FIG. 3 is a right-angle sectional view of the present invention.

FIG. 4 is an assembly explosive view of the present invention.

In the drawings, the reference numerals refer to the following components: 1—machine chip body; 2—upper positioning bearing: 3—lower positioning bearing; 4—wireless power supply mechanism; 5—upper wireless photoelectric communication circuit board; 6—ranging receiving lens; 7—ranging transmitting lens; 8—ranging mainboard; 9—ranging transmitting board; 10—ranging receiving board; 11—gating structure; 12—photoelectric switch; 13—brushless motor rotor; 14—transmitting reflector adjusting slider; 15—receiving reflector adjusting slider; 16—counterweight.

### DETAILED DESCRIPTION

The present invention is further described below in detail in combination with the drawings and embodiments.

### Embodiments

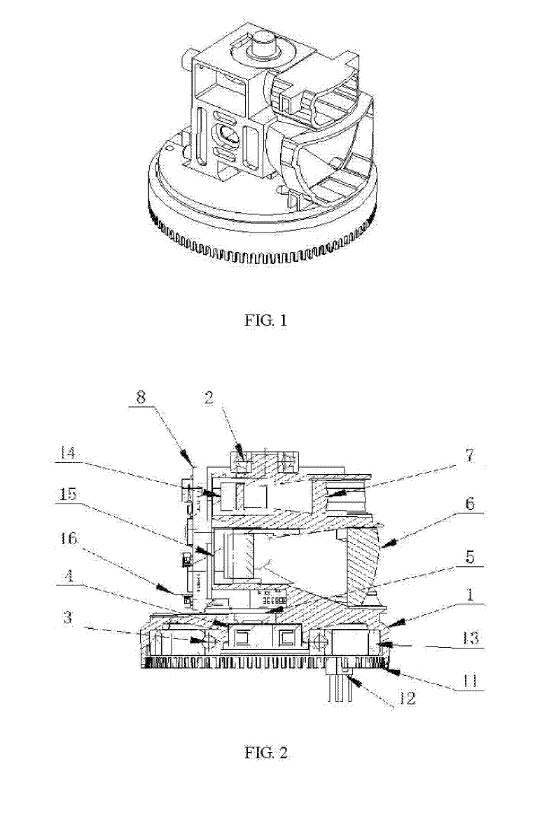

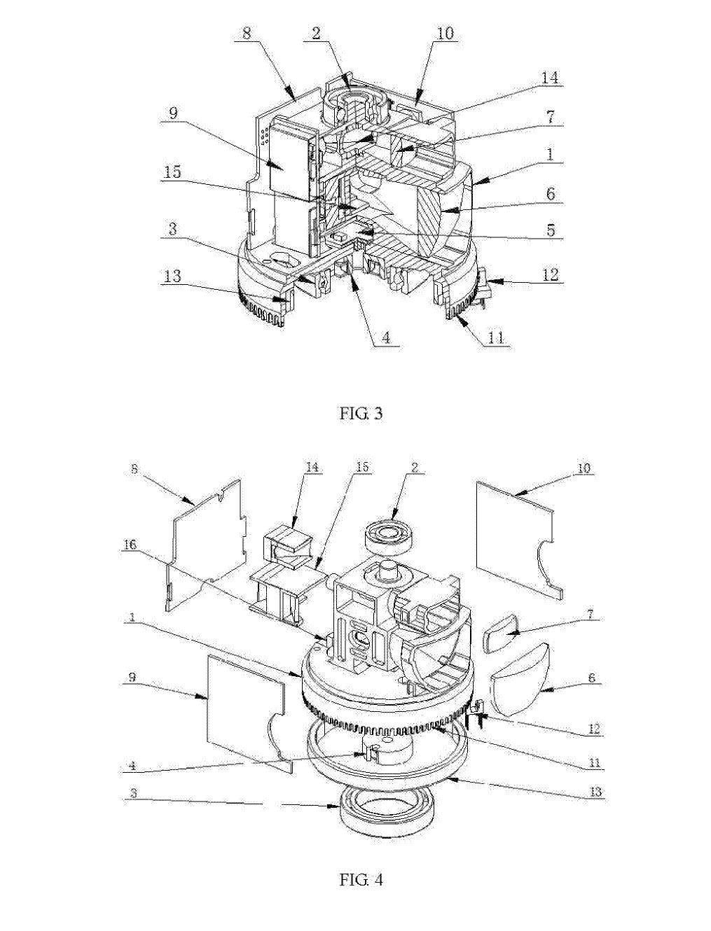

An integrated rotary machine chip for a laser radar sensor, as shown in FIG. 1-FIG. 4, comprising: a machine chip body 1, wherein two positioning bearings 2, 3 are arranged on the upper side and the lower side of the machine chip body 1 respectively, the two positioning bearings 2, 3 are coaxial, the machine chip body 1 includes a ranging transmitting board 9, a ranging receiving board 10, a laser ranging transmitting module, a laser ranging receiving module and a ranging mainboard 8, wherein the ranging transmitting board 9 and the ranging receiving board 10 are arranged on the front side and the rear side of the machine chip body 1 respectively, the ranging mainboard 8 is arranged on the left side of machine chip body 1, the machine chip body 1 is provided with a transmitting cavity and a receiving cavity, the transmitting cavity is located right above the receiving cavity, and the laser ranging transmitting module and the laser ranging receiving module are located in the transmitting cavity and the receiving cavity respectively. The machine chip body 1 is also provided with a counterweight 16. Wherein, the ranging transmitting board 9, and the ranging receiving board 10 and the ranging mainboard 8 are interchangeable in position according to needs.

The laser ranging transmitting module comprises a transmitting reflector adjusting slider 14 and a ranging transmitting lens 7 fixed to the transmitting reflector adjusting slider 14, and the laser ranging receiving module comprises a receiving reflector adjusting slider 15 and a ranging receiving lens 6 fixed to the receiving reflector adjusting slider 15, wherein the transmitting reflector adjusting slider 14 and the receiving reflector adjusting slider 15 are used to adjust positions of corresponding lenses.

The integrated rotary machine chip for a laser radar sensor further comprises a brushless motor rotor 13, a wireless power supply mechanism 4, an upper wireless photoelectric communication circuit board 5 and a lower wireless photoelectric communication circuit board, wherein the brushless motor rotor 13 is connected with the machine chip body 1 to drive the machine chip body 1 to rotate, and the upper wireless photoelectric communication circuit board 5 is communicatively connected with the lower wireless photoelectric communication circuit board; one end of the wireless power supply mechanism 4 is electrically connected with the lower wireless photoelectric communication circuit board, the other end thereof is electrically connected with the ranging mainboard 8 and the upper wireless photoelectric communication circuit board 5, and the wireless power supply mechanism is used to supply power for the laser ranging module. The wireless power supply mechanism 4 supplies power for a magnetic core or supplies power for an internal/external transformer.

A grating structure 11 and a photoelectric switch 12 matched with the grating structure 11 are arranged at the bottom of the machine chip body 1, the photoelectric switch 12 is matched with the grating structure 11 to detect the rotation speed, the brushless motor rotor 13 is located on the inside of the grating structure 11, and the brushless motor rotor 13 is surrounded by the grating structure 11. Wherein, a base matched with the machine chip body is arranged at the bottom of the machine chip body 1, and the grating structure 11 and the photoelectric switch 12 are arranged on the machine chip body 1 and the base respectively and are interchangeable in position. When the machine chip body 1 rotates, the photoelectric switch 12 calculates the rotation speed of the machine chip by reading the time interval of each part of the grating structure 11.

The ranging transmitting lens 7 is a 45-degree angle reflector or a 45-degree angle prism, and the ranging receiving lens 6 is a 45-degree angle reflector or a 45-degree angle prism.

An enclosure is also arranged on the outside of the machine chip body 1, the machine chip body 1 is surrounded by the enclosure, and the transmitting cavity and receiving cavity are in small clearance fit with the inner wall of the enclosure.

In short, the above is just one preferred embodiment of the present invention. All equivalent variations and modifications made in accordance with the scope of the application patent of the present invention shall belong to the scope covered by the patent of the present invention.

1. An integrated rotary machine chip for a laser radar sensor, comprising: a machine chip body (1), wherein two positioning bearings (2, 3) are arranged on the upper side and the lower side of the machine chip body (1) respectively, the two positioning bearings (2, 3) are coaxial, the machine chip body (1) includes a ranging transmitting board (9), a ranging receiving board (10), a laser ranging transmitting module, a laser ranging receiving module and a ranging mainboard (8), wherein the ranging transmitting board (9) and the ranging receiving board (10) are arranged on the front side and the rear side of the machine chip body (1) respectively, the ranging mainboard (8) is arranged on the left side of machine chip body (1), the machine chip body (1) is provided with a transmitting cavity and a receiving cavity, the transmitting cavity is located right above the receiving cavity, and the laser ranging transmitting module and the laser ranging receiving module are located in the transmitting cavity and the receiving cavity respectively.

2. The integrated rotary machine chip for a laser radar sensor according to claim 1, wherein the laser ranging transmitting module comprises a transmitting reflector adjusting slider (14) and a ranging transmitting lens (7) fixed to the transmitting reflector adjusting slider (14), and the laser ranging receiving module comprises a receiving reflector adjusting slider (15) and a ranging receiving lens (6) fixed to the receiving reflector adjusting slider (15), wherein the transmitting reflector adjusting slider (14) and the receiving reflector adjusting slider (15) are used to adjust positions of corresponding lenses.

3. The integrated rotary machine chip for a laser radar sensor according to claim 1, further comprising: a brushless motor rotor (13), a wireless power supply mechanism (4), an upper wireless photoelectric communication circuit board (5) and a lower wireless photoelectric communication circuit board, wherein the brushless motor rotor (13) is connected with the machine chip body (1) to drive the machine chip body (1) to rotate, and the upper wireless photoelectric communication circuit board (5) is communicatively connected with the lower wireless photoelectric communication circuit board: one end of the wireless power supply mechanism (4) is electrically connected with the lower wireless photoelectric communication circuit board, the other end thereof is electrically connected with the ranging mainboard (8) and the upper wireless photoelectric communication circuit board (5), and the wireless power supply mechanism is used to supply power for the laser ranging module.

4. The integrated rotary machine chip for a laser radar sensor according to claim 3, wherein a grating structure (11) and a photoelectric switch (12) matched with the grating structure (11) are arranged at the bottom of the machine chip body (1), the photoelectric switch (12) is matched with the grating structure (11) to detect the rotation speed, the brushless motor rotor (13) is located on the inside of the grating structure (11), and the brushless motor rotor (13) is surrounded by the grating structure (11).

5. The integrated rotary machine chip for a laser radar sensor according to claim 3, wherein the wireless power supply mechanism (4) supplies power for a magnetic core or supplies power for an internal/external transformer.

6. The integrated rotary machine chip for a laser radar sensor according to claim 1, wherein the ranging transmitting lens (7) is a 45-degree angle reflector or a 45-degree angle prism, and the ranging receiving lens (6) is a 45-degree angle reflector or a 45-degree angle prism.

7. The integrated rotary machine chip for a laser radar sensor according to claim 1, wherein the machine chip body (1) is also provided with a counterweight (16).

8. The integrated rotary machine chip for a laser radar sensor according to claim 1, wherein an enclosure is also arranged on the outside of the machine, chip body (1), the machine chip body (1) is surrounded by the enclosure, and the transmitting cavity and receiving cavity are in small clearance fit with the inner wall of the enclosure.

9. The integrated rotary machine chip for a laser radar sensor according to claim 1, wherein a base matched with the machine chip body is arranged at the bottom of the machine chip body (1).
